(19) United States
(12) Patent Application Publication
(10) Pub. No.: US 2008/0245683 A1
(43) Pub. Date: Oct. 9, 2008

(54) Container for Keeping Component Separate up to Their Use

(75) Inventors: Larry McKenna, Dallas, TX (US); Chris Record, Dallas, TX (US)

Correspondence Address: CHALKER FLORES, LLP, 2711 LBJ FRWY, Suite 1036, DALLAS, TX, 75234, US

(73) Assignee: INJEXXION, INC., Dallas, TX (US)

(21) Appl. No.: 11/696,668

(22) Filed: Apr. 4, 2007

(51) Int. Cl. B67D 5/56

(52) U.S. Cl. 206/219; 222/129

(57) ABSTRACT

The present invention includes dispensers, containers, methods of making and using dispensers with a fitting to attach to a second container and position a reservoir about the second container. The reservoir includes a diaphragm positioned opposite an orifice and a hollow perforator slidably positioned in the orifice. The hollow perforator includes a perforator portion and an access port portion that forms a chamber to hold one or more components. The one or more components may be released from the chamber without the removal of the dispenser from a container.

### TECHNICAL FIELD OF THE INVENTION

The present invention relates in general to the field of keeping products separated prior to use, and in particular to maintaining a separation of a beverage concentrate for use by consumers in mixing with the contents of the bottle just prior to use.

### BACKGROUND OF THE INVENTION

Without limiting the scope of the invention, its background is described in connection with container that maintains a separation between substances until use, when they can be mixed and consumed in the container.

There is often a need to keep substances separated until they are to be mixed and/or used. This allows fresher solutions, increased shelf-lives, and the retention of the physical characteristics (e.g., color, taste, reactivity, etc.) of the mixture. This is seen in the beverage industry and in the pharmaceutical industry where components must be mixed together just before administering the products; the separated individual substances remain stable longer than the product obtained from the combination. For example, medicines can be packaged in separate phases one a solid and the other a liquid, which can be open and mixed together just prior to administering to the patient.

In addition, it is often inconvenient to transport, store, and separate out the individual components for preparation of individual portions. For example, when making individual portions, the bulk components are purchased, stored and divided into individual portions and placed into individual containers. This is often the case for campers, hikers, sports events, parties, disaster relief, emergency situations and many other situations. However, these methods result in the consumption of material and produce waste materials.

U.S. Pat. No. 7,025,200 entitled “Bottle for two-component extemporaneous products” teaches a bottle for two-component extemporaneous products. It includes a container for a first component, which is provided with an upper mouth; a reservoir for containing a second component, which is inserted substantially coaxially in the mouth, is open upward and has a bottom constituted by a diaphragm; a perforator, which can be inserted in the reservoir and is adapted to pierce the diaphragm in order to mix the two components; and a removable cap for closing the container in an upward region. The cap includes a lower annular portion that is fixed to the container and an upper cylindrical portion that cooperates with the perforator and is rigidly coupled to the annular portion at an intermediate weakened region suitable to act as sealing means, a downward pressure on the cylindrical portion being adapted to disengage it from the annular portion and to make the perforator slide in the reservoir in order to pierce the underlying diaphragm.

U.S. Pat. No. 6,435,341 entitled “Child proof sealing device for a container of substances to be kept separate up to their dispensing” teaches a sealing device to kept substances separate up to their dispensing. It includes an inner cap and an outer cap inserted idly on the inner cap. The inner cap offers a cavity, which forms a chamber capable of containing a product. The chamber is sealed by a sealing element controlled at the opening time, so that the opening of the chamber causes a product contained in the chamber to be mixed with a second product contained in the same container, where said inner cap is fitted with an internally threaded element capable of coupling with a corresponding threaded portion of the container and of engaging with the outer cap by some male-female elements arranged on the inner cap and on the outer cap.

U.S. Pat. No. 6,372,270 entitled, “Drink mix apparatus for making personal quantities of beverage” teaches a methods and apparatus for making or brewing personal quantities of beverages using bottled water, in a conventional or specially formed bottle. The cap assembly includes an outer attachment portion and a plunger portion fitting within the attachment portion. The two portions define a chamber therein containing a drink mix, one or more tea bags, etc. A seal is provided to prevent mixing of the drink mix and water within the bottle until desired. When the plunger is pushed downwardly, it drives the drink mix through the seal, bursting the seal and deploying the drink mix or tea bags into the water within the bottle. Still another embodiment comprises tea bags or drink mix packets, which are specially shaped and configured for ease of insertion into the relatively narrow neck of a bottle of water.

U.S. Pat. No. 6,412,526 entitled, “Device for maintaining separate ingredients in liquid food products” teaches a device for maintaining ingredients separately within a container, of the type having a removable container cap applied on a neck with a central opening, has a sub-container body mounted in the container neck which is formed with a proximate end having screw threads which can be engaged with internal screw threads in the container neck for holding them securely together to allow the ingredients to be shaken out of the sub-container body and mixed with fluid in the container. The sub-container body can have inner divider walls forming multiple compartments with respective orifices for dispensing ingredients selectively from the compartments. The sub-container body may be sealed to the underside of the cap with a sealing film, or seated on the neck rim and held by the cap. In one version, the proximate end of the sub-container body has a protruding shape with inclined walls for guiding it into the neck opening.

U.S. Pat. No. 7,172,095 entitled, “Bottle closure containing beverage concentrate” teaches a controlled flow re-sealable bottle closures containing a beverage concentrate for use in mixing flavored water-based beverages at or near the point of consumption by activation of a mixing mechanism allowing the contents of the bottle to co-mingle with the beverage concentrate.

U.S. Pat. No. 6,702,161 entitled, “Closure having rotatable spout and axially movable stem” teaches a closure for a container having a foil or membrane sealed opening. The closure includes a cap, a spout and a stem. The stem includes a downwardly extending piercing structure adapted for piercing the foil or membrane of the container upon rotation of the spout relative to the cap.

However, the designs currently in use do not allow the consumption of the substances without the disassembly of the container to provide access. The cap and an outer cap inserted idly on the inner cap seal the container and must therefore be removed. Although this arrangement does allow the components to remain separated, it does not provide a simple and convenient manner to consume the contents that doesn't involve disassembly of the container.

### SUMMARY OF THE INVENTION

The present inventors recognized that making a mixture of components for individual use involves many drawbacks including the fact that they are time-consuming and difficult to prepare the mixtures and entail significant consumption of materials and create numerous waste materials.

The present inventors recognized a need for a container that could keep multiple components separate until they are dispensed, while allowing the components to be dispensed without the disassembly of portions of the container. The present inventors recognized a need for a container and/or an insert designed to fit commercial containers while allowing both mixing and consumption from the same container.

The present invention provides a dispenser that is adapted to fit the mouth of a conventional bottle, e.g., water bottle, bottled water, sport drink, soda and so forth. The dispenser has a reservoir that contains a concentrate that can be dispensed into the container and mixed for consumption. The reservoir includes a diaphragm to seal the concentrate within the reservoir and a hollow perforator that can be moved to pierce the diaphragm. In this manner, the component contained in the reservoir is poured into the container, where it mixes with the other component in order to prepare the product to be administered. A downward motion on the hollow perforator forces it through the diaphragm to release the concentrate for mixing. Generally, the concentrate is in powder or granular form and the other is in liquid form; the former dissolves or disperses in the latter. The mixture can then be consumed through the hollow perforator directly without the need for disassembly and removal of the reservoir.

The present invention provides a dispenser having a fitting positioned circumferentially about a reservoir to attach the dispenser to a second container. The reservoir includes an orifice and a diaphragm positioned opposite the orifice. A hollow perforator is slidably positioned in the orifice of the reservoir and includes a perforator portion and an access port portion opposite the perforator portion. The reservoir and the hollow perforator form a chamber to hold one or more components, e.g., concentrates.

The present invention also provides a method of dispensing one or more components for mixing. A container is first attached to a dispenser by a fitting. The dispenser includes a reservoir with an orifice and a diaphragm positioned opposite the orifice. A hollow perforator is slidably positioned in the orifice includes a perforator portion and an access port portion opposite the perforator portion. The reservoir and the hollow perforator form a chamber holding one or more components and a fitting positioned circumferentially about the reservoir to attach the dispenser to the container. The hollow perforator is slidable so that it can be moved to pierce the diaphragm and release the one or more components from the chamber into the container.

The present invention provides a method of making an individual portion dispenser for holding separately one or more components prior to mixing, consumption and dispensing by making a dispenser that can be attached to a commercial container by a fitting. The dispenser includes a reservoir with an orifice and a diaphragm end positioned opposite the orifice. A hollow perforator slidably positioned in the orifice and includes a perforator portion and an access port portion opposite the perforator portion. The reservoir and the hollow perforator form a chamber holding one or more components and a fitting positioned circumferentially about the reservoir to attach the dispenser to the container. The desired quantity of one or more components is added to the reservoir and chamber. A diaphragm is placed about the diaphragm end to seal the chamber and reservoir and maintain separation from the environment.

The present invention also provides a container for holding a first component and having an aperture for dispensing the content of the container. A dispenser is fitted to the aperture by a fitting positioned circumferentially about a reservoir to attach the dispenser to the container. The dispenser includes a reservoir having an orifice and a diaphragm positioned opposite the orifice, a hollow perforator slidably positioned in the orifice of the reservoir. The perforator includes a perforator portion and an access port portion opposite the perforator portion. The reservoir and the hollow perforator form a chamber to hold one or more components.

The present invention also provides a pharmaceutical product in an individual dose container that includes two or more components in a non-premixed form. The individual dose container keeps two or more substances separate until their moment of usage, when they are mixed to maintain the therapeutic effect of the pharmaceutical product and without the need for measuring or transferring the contents from container to container. The individual dose container includes a first component and an aperture. A dispenser is fitted to the aperture by a fitting positioned circumferentially about a reservoir to attach the dispenser to the container. The dispenser includes a reservoir having an orifice and a diaphragm positioned opposite the orifice, a hollow perforator slidably positioned in the orifice of the reservoir. The perforator includes a perforator portion and an access port portion opposite the perforator portion. The reservoir and the hollow perforator form a chamber to hold one or more components.

### BRIEF DESCRIPTION OF THE DRAWINGS

For a more complete understanding of the features and advantages of the present invention, reference is now made to the detailed description of the invention along with the accompanying figures and in which:

FIG. 1 is a perspective view of the dispenser of the present invention and a first container;

FIG. 2 is a cutaway view of the dispenser of the present invention;

FIG. 3 is an exploded view of the dispenser of the present invention;

FIG. 4 is a cutaway view of the dispenser of the present invention;

FIGS. 5A-5D are side views of the dispenser of the present invention;

FIG. 6 is a side view of the dispenser with the hollow perforator piercing the diaphragm;

FIG. 7 is a cutaway view of the dispenser of the present invention;

FIG. 8 is a side view of the dispenser of the present invention in operation;

FIG. 9 is a cut-away view of the dispenser having multiple component chambers of the present invention; and

FIG. 10A is a cut-away view of the dispenser of the present invention having multiple component chambers; FIGS. 10B-10E are bottom views of the dispenser of the present invention as illustrated in FIG. 10A.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The present invention provides a container, a kit, an insert for commercial containers and a method of making and using a dispenser capable of keeping multiple components separated until the moment of usage, when they are combined, mixed and consumed.

The dispenser includes a fitting to attach the dispenser to a second container and includes a fitting port that holds a reservoir within at least a portion of the mouth of the second container. The reservoir is sealed by a diaphragm on one end that is positioned opposite an orifice at the other. A hollow perforator is slidably positioned in the orifice of the reservoir to form a chamber for holding one or more components (not shown). The hollow perforator includes a perforator portion at one end and an access port portion at the other to form a chamber that extend from the diaphragm to the access port portion of the hollow perforator. The chamber is sealed at one end by the diaphragm and at the other end by the access port portion to maintain a separation from the environment.

When the components are to be mixed, the hollow perforator is moved in a downward motion and slides within the orifice of the reservoir toward the diaphragm. As the hollow perforator moves, the perforator portion contacts the diaphragm; as more pressure is applied, the perforator portion penetrates the diaphragm to release the contents of the reservoir into the second container for mixing. Once the contents of the reservoir have been released the dispenser remains attached to the second container and connects the reservoir from the perforator portion to the access port portion. The access port portion seals the interior of the second container from the environment. Once the access port portion is unsealed the contents of can be released, consumed or otherwise used. Although, the skilled artisan will recognize that there are numerous methods of sealing the access port portion, common examples include a conventional pop-up top, a twist top, a removable film or cap.

In the storage of liquid foodstuffs, beverages and water, the product can have better flavor, a longer shelf life, contain less preservatives, and/or use less stable ingredients that are stored separately from the carrier liquid until the product is to be consumed. For example, a beverage can have better taste if the flavoring is stored in dry form and mixed with a liquid just prior to use. For example, some beverages, spices, oils, vitamins, supplements, flavorings, medicines, and other ingredients when mixed with water, soda, or other liquid media are unstable, and therefore may not be used with currently sold beverages and liquid mixtures. Many beverages, sauces, and condiments require high levels of preservatives to control fermentation with sugar content.

The present invention also provides a container for dispensing one or more components. The container includes an aperture and holds a first component. A dispenser is fitted to the aperture of the container by a fitting. The fitting is positioned circumferentially about a reservoir and attaches the dispenser to the container. The dispenser includes a reservoir having an orifice and a diaphragm positioned opposite the orifice, a hollow perforator slidably positioned in the orifice of the reservoir, the perforator comprising a perforator portion and an access port portion opposite the perforator portion. The reservoir and the hollow perforator form a chamber to hold one or more components.

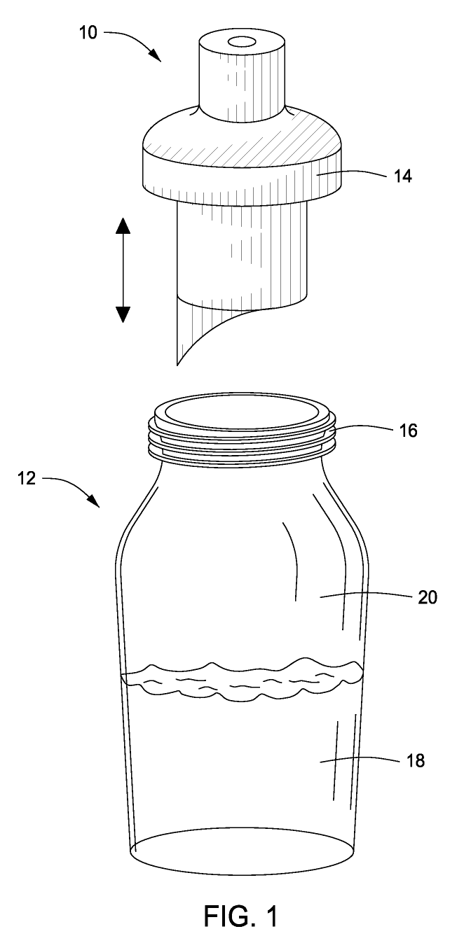

FIG. 1 is a perspective view of the dispenser of the present invention. The dispenser 10 is shown with the second container 12. The dispenser 10 includes a fitting 14 that is used to attach the dispenser 10 to the second container 12. The fitting 14 may include many different mechanisms to attach the dispenser 10 to the second container 12. For example, the fitting 14 may be threaded to receive the threads 16 of the second container 12; however, other embodiment of the fitting 14 may take different forms (e.g., a compression fitting, a threaded fitting, a friction fitting, a childproof fitting, or a combination thereof) depending on the mating fitting 16 of the second container 12. The dispenser 10 may contain a first substance that is separated from the second container 12, which has a second component 18 within the contents chamber 20 of the second container 12. This allows the contents of the dispenser 10 to remain separate from the contents of the second container 12 until mixed.

The fitting 14 can be used with a container 12 of the type often used for bottled water, sport drinks and other liquid bottled substances. The fitting 14 may have threads 16, a stopper, a clamp, a compression fitting a rubber seal and so forth to seal the second container 12 from the environment. The dispenser 10 of the present invention is particularly suited for use with containers having an opening that is sealed by a set of threads 16. The dispenser 10 includes a fitting 14 that is adapted for releasably engaging the container 12 and includes an aperture to allow access to the content chamber 20 of the container.

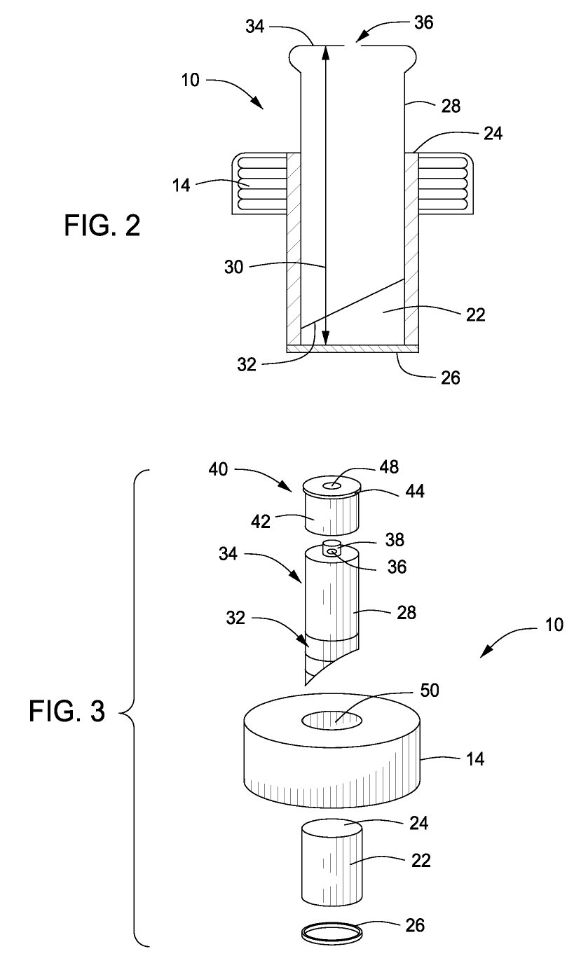

FIG. 2 is a cutaway view of the dispenser 10 of the present invention and includes a reservoir 22 having an orifice 24 and a diaphragm 26 positioned opposite the orifice 24. A hollow perforator 28 is slidably positioned in the orifice 24 of the reservoir 22 to form a chamber 30 for holding one or more components (not shown). The hollow perforator 28 includes a perforator portion 32 and an access port portion 34 opposite the perforator portion 32. The access port portion 34 includes an access aperture 36 that allows communication between the chamber 30 and the outside environment. The reservoir 22 and the hollow perforator 28 form the chamber 30 for holding one or more components, substances, compounds, mixtures, concentrates and so forth. A fitting 14 is positioned circumferentially about the reservoir 22 to attach the dispenser 10 to the second container (not shown).

FIG. 3 is an exploded view of the dispenser 10 illustrates a reservoir 22 having an orifice 24 and a diaphragm 26 positioned opposite the orifice 24. A hollow perforator 28 is slidably positioned in the orifice 24 of the reservoir 22 to form a chamber (not shown) for holding one or more components (not shown). The hollow perforator 28 includes a perforator portion 32 and an access port portion 34 opposite the perforator portion 32. The access port portion 34 includes an access aperture 36 that is positioned on the sides of a sealing portion 38. A sealing cap 40 including a sealing aperture 42 positioned opposite a dispensing portion 44 having a sealing port 48. The sealing aperture 42 of the sealing cap 40 slidable engages the hollow perforator 28 to align and seal the sealing portion 38 with the sealing port 48 to separate the contents of the chamber (not shown) from the environment. The sealing portion 38 and the sealing port 48 are sized and shaped to frictionally mate to each other. When the sealing portion 38 and the sealing port 48 are in the closed position, the access aperture 36 seals the sides of a sealing portion 38, whereas in the open position the environment is connected to the chamber 30 through the sealing port 48 and the access aperture 36. A fitting 14 is positioned circumferentially about the reservoir 22 by a fitting port 50. The fitting 14 is adapted to attach the dispenser 10 to the second container (not shown).

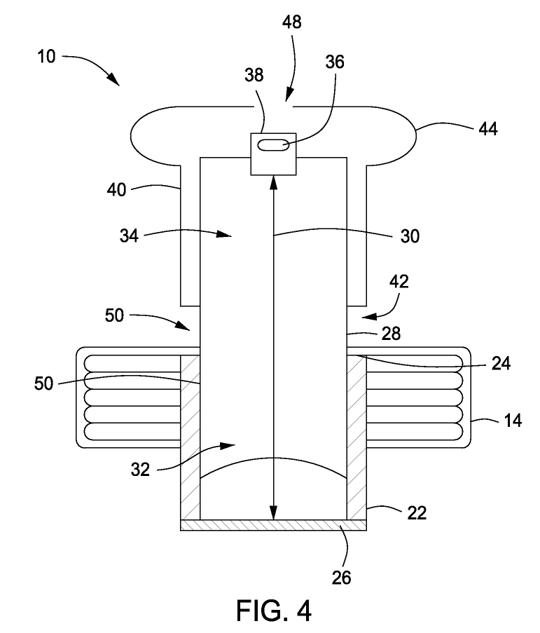

FIG. 4 is a cut-away view of the dispenser 10 of the present invention. The dispenser 10 includes a fitting 14 to attach the dispenser 10 to the second container (not shown). The fitting 14 has a fitting port 50 holding a reservoir 22 within the top of the second container (not shown). The reservoir 22 is sealed by a diaphragm 26 positioned opposite a orifice 24. A hollow perforator 28 is slidably positioned in the orifice 24 of the reservoir 22 to form a chamber 30 for holding one or more components (not shown). The hollow perforator 28 includes a perforator portion 32 and an access port portion 34 opposite the perforator portion 32. The access port portion 34 includes one or more access apertures 36 are positioned on the sides of a sealing portion 38. The access apertures 36 are positioned to seal by mating the sealing port 48 to fit frictionally the sealing portion 38. The sealing port 48 is located on the dispensing portion 44 of the sealing cap 40, opposite the sealing aperture 42. The sealing cap 40 slidable engages the hollow perforator 28 at the sealing aperture 42.

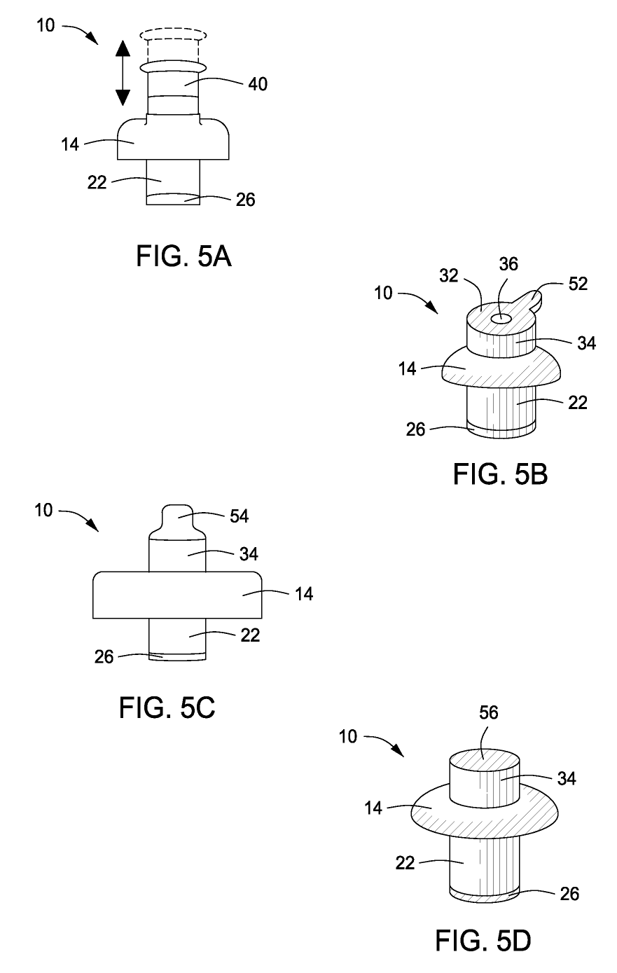

FIGS. 5A-5D are side views of the dispenser 10 of the present invention. FIG. 5A is a side view of the dispenser 10 having a “pop-top” to allow access to the contents of reservoir 22 sealed in the chamber (not shown) by the sealing cap 40 and the diaphragm 26. Once the fitting 14 is fitted to the second container (not shown), the hollow perforator (not shown) can be moved in a downward motion to pierce or release the diaphragm 26. The piercing of the diaphragm 26 results in the contents of the chamber (not shown) being released into the second container (not shown) for mixing. The sealing cap 40 may then be moved in an upward motion to slide the sealing port (not shown) of the sealing cap 40 from the sealing portion (not shown) and unseal the access aperture (not shown). This allows the contents to be dispensed and/or consumed. The sealing cap 40 may later be moved in a downward motion to slide the sealing port (not shown) of the sealing cap 40 to contact the sealing portion (not shown) and reseal the access apertures (not shown).

FIG. 5B is a side view of the dispenser 10 having a sealing film 52 to allow access to the contents of reservoir 22 sealed in the chamber (not shown) by the diaphragm 26 and the sealing film 52 positioned over the access port portion 34 and one or more access apertures 36. Once the fitting 14 is fitted to the second container (not shown), the hollow perforator (not shown) can be moved in a downward motion to pierce the diaphragm 26. The piercing of the diaphragm 26 results in the contents of the chamber (not shown) being released into the second container (not shown) for mixing. The sealing film 52 may be removed from the access port portion 34 to expose the one or more access apertures 36 allowing the contents to be dispensed and/or consumed.

FIG. 5C is a side view of the dispenser 10 having a removable tab 54 to allow access to the contents of reservoir 22 sealed in the chamber (not shown) by the diaphragm 26 and the removable tab 54 positioned over the access port portion 34 and one or more access apertures 36. Once the fitting 14 is fitted to the second container (not shown), the hollow perforator (not shown) can be moved in a downward motion to pierce the diaphragm 26. The piercing of the diaphragm 26 results in the contents of the chamber (not shown) being released into the second container (not shown) for mixing. The removable tab 54 may be removed from the access port portion 34 to expose the one or more access apertures (not shown) allowing the contents to be dispensed and/or consumed. In some embodiments, the removable tab 54 has a weaken region that may be torn for removal, the removable tab 54 may be cut, the removable tab 54 may be constructed of different materials to allow removal, or other methods known to the skilled artisan.

FIG. 5D is a perspective view of the dispenser 10 having a second diaphragm 56 to allow access to the contents of reservoir 22 sealed in the chamber (not shown) by the diaphragm 26 and the second diaphragm 56 positioned over the access port portion 34. Once the fitting 14 is fitted to the second container (not shown), the hollow perforator (not shown) can be moved in a downward motion to pierce or release the diaphragm 26. The second diaphragm 56 may be pierced by the sides fitting (not shown), the hollow perforator (not shown), an external object (not shown) or the contents of the chamber (not shown) to release the second diaphragm 56. The piercing of the diaphragm 26 results in the contents of the chamber 30 being released into the second container (not shown) for mixing. The second diaphragm 56 allows the contents to be dispensed and/or consumed.

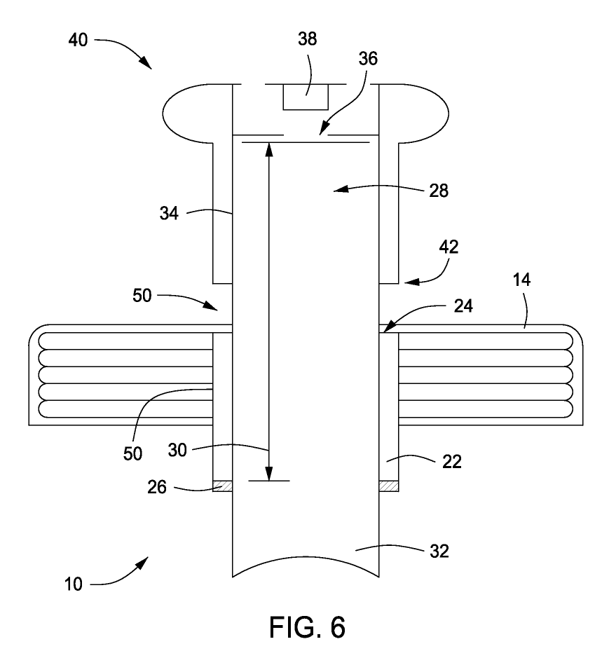

FIG. 6 is a side view of the dispenser 10 with the hollow perforator piercing the diaphragm. The dispenser 10 includes a hollow perforator 28 is slidably positioned in the orifice 24 of the reservoir 22 to form a chamber 30 for holding one or more components (not shown). The reservoir 22 is sealed by a diaphragm 26 positioned opposite an orifice 24. The hollow perforator 28 includes a perforator portion 32 and an access port portion 34 opposite the perforator portion 32. As the hollow perforator 28 is moved downwardly the perforator portion 32 dislodges the diaphragm 26. The perforator portion 32 allows the contents of the chamber 30 to be released for mixing, while the access port portion 34 allows the contents of the chamber 30 to be consumed. A sealing cap 40 including a sealing aperture 42 positioned opposite a dispensing portion 44 having a sealing port 48. The sealing aperture 42 of the sealing cap 40 slidable engages the hollow perforator 28 to align and seal the sealing portion 38 with the access aperture 36 to separate the contents of the chamber (not shown) from the environment. The sealing portion 38 and the access aperture 36 are sized and shaped to frictionally mate to each other. When the sealing portion 38 and the access aperture 36 are in the closed position the access aperture 36 is sealed, whereas in the open position the environment is connected to the chamber 30 through the sealing portion 38 and the access aperture 36. A fitting 14 is positioned circumferentially about the reservoir 22 by a fitting port 50. The fitting 14 is adapted to attach the dispenser 10 to the second container (not shown).

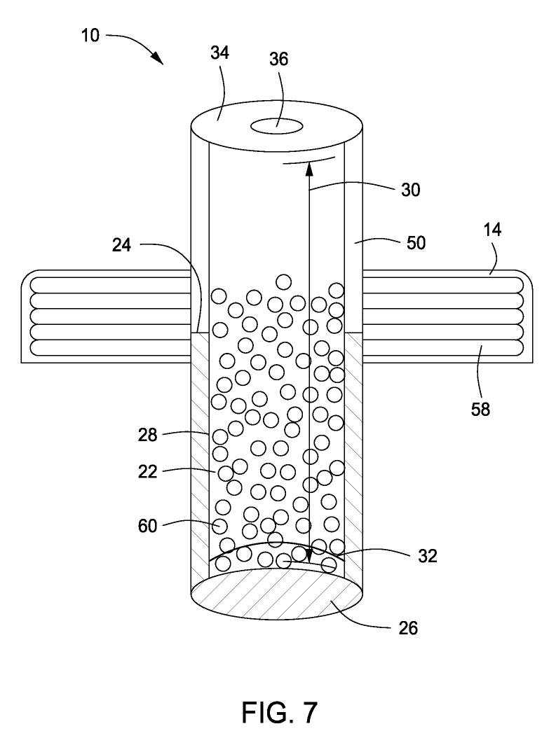

FIG. 7 is a cut-away view of the dispenser 10 of the present invention. The dispenser 10 includes a fitting 14 having threads 58 to attach the dispenser 10 to the second container having mating threads (not shown). The fitting 14 has a fitting port 50 holding a reservoir 22 within the top of the second container (not shown). The reservoir 22 is sealed by a diaphragm 26 positioned opposite an orifice 24. A hollow perforator 28 is slidably positioned in the orifice 24 of the reservoir 22 to form a chamber 30 for holding one or more components 60. The hollow perforator 28 includes a perforator portion 32 and an access port portion 34 opposite the perforator portion 32. As the hollow perforator 28 is moved downwardly the perforator portion 32 dislodges the diaphragm 26.

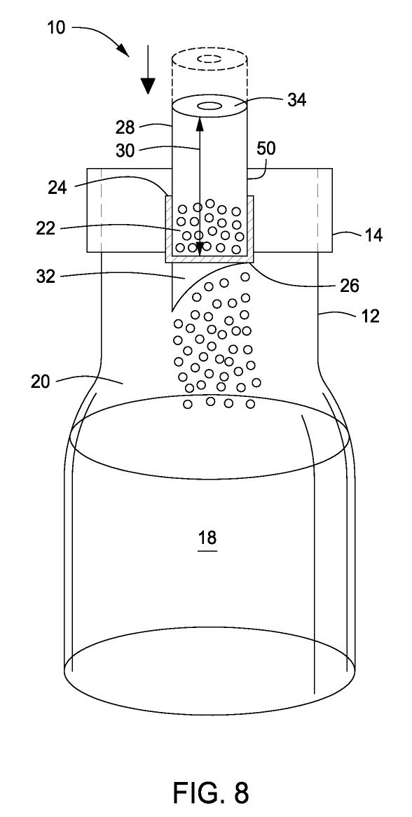

FIG. 8 is a side view of the dispenser of the present invention. The dispenser 10 includes a fitting 14 to attach the dispenser 10 to the second container 12. The fitting 14 has a fitting port 50 holding a reservoir 22 within the top of the second container 12. The reservoir 22 is sealed by a diaphragm 26 positioned opposite an orifice 24. A hollow perforator 28 is slidably positioned in the orifice 24 of the reservoir 22 to form a chamber 30 for holding one or more components 60. The hollow perforator 28 includes a perforator portion 32 and an access port portion 34 opposite the perforator portion 32. As the hollow perforator 28 is moved downwardly the perforator portion 32 dislodges the diaphragm 26. The perforator portion 32 allows the one or more components 60 of the chamber 30 to be released for mixing with the second component 18 within the contents chamber 20 of the second container 12.

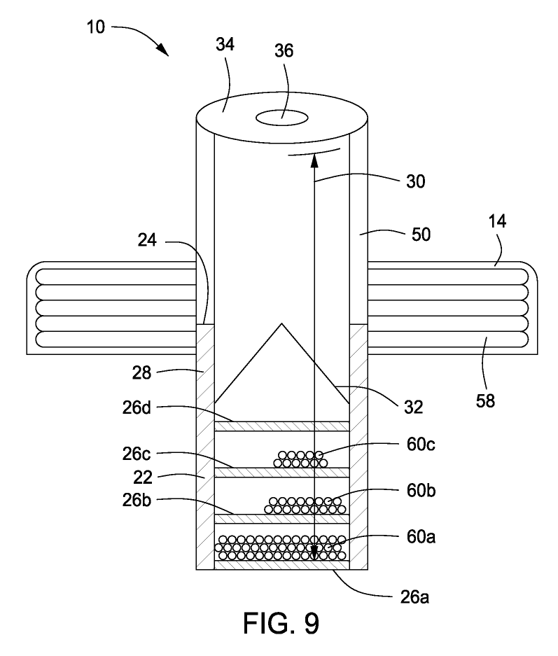

FIG. 9 is a cut-away view of the dispenser of the present invention. The dispenser 10 includes a fitting 14 having threads 58 to attach the dispenser 10 to the second container having mating threads (not shown). The fitting 14 has a fitting port 50 holding a reservoir 22 within the top of the second container (not shown). The reservoir 22 is sealed by a diaphragm 26 positioned opposite an orifice 24. A hollow perforator 28 is slidably positioned in the orifice 24 of the reservoir 22 to form a chamber 30. The hollow perforator 28 includes a perforator portion 32 and an access port portion 34 opposite the perforator portion 32. The chamber 30 may hold more than one component that is separated from the other components. For example, components 60a is enclosed by diaphragm 26a and separated from components 60b by the diaphragm 26b, which is in-turn separated from components 60c by the diaphragm 26c and sealed into the chamber by diaphragm 26d. As the hollow perforator 28 is moved through the chamber 30 the perforator portion 32 penetrates the diaphragms 26a-26d to release the components 60a-60c.

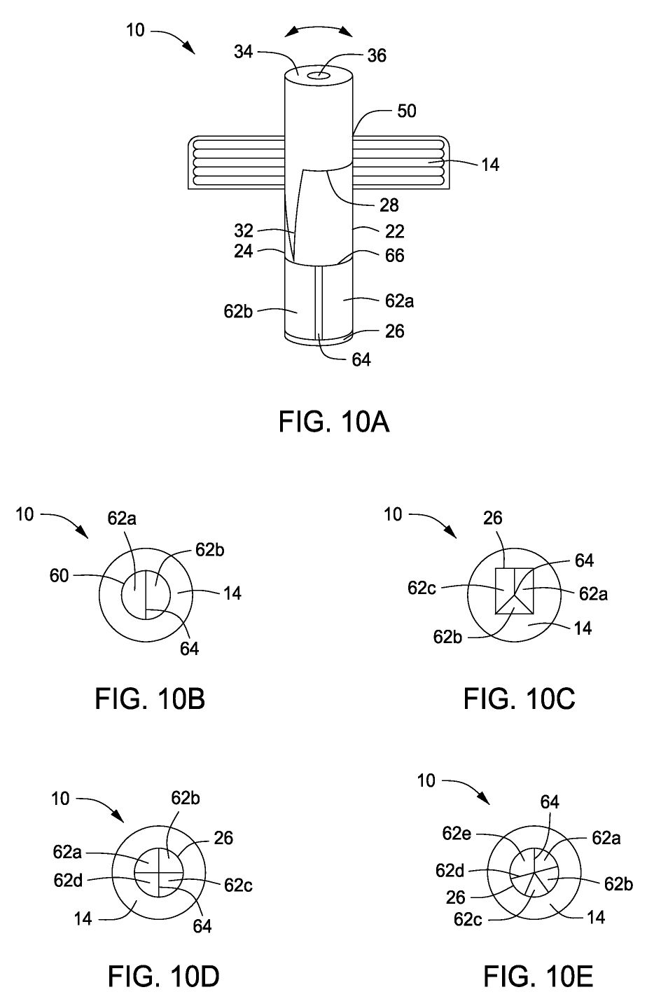

FIG. 10A is a cut-away view of the dispenser of the present invention. The dispenser 10 includes a fitting 14 having threads (not shown) to attach the dispenser 10 to the second container having mating threads (not shown). The fitting 14 has a fitting port 50 holding a reservoir 22 within the top of the second container (not shown). The reservoir 22 is sealed by a diaphragm 26 positioned opposite an orifice 24. The reservoir 22 is divided into separate compartments 62a and 62b by the divider 64 and seal 66 to allow each of the separate compartments 62a and 62b to hold different components (not shown). A hollow perforator 28 is slidably positioned in the orifice 24 of the reservoir 22 and includes a perforator portion 32 and an access port portion 34 opposite the perforator portion 32. A hollow perforator 28 may be twisted to position the perforator portion 32 over the corresponding compartments 62a and 62b. In some instances, the corresponding compartments 62a and 62b may be labeled on the top of the dispenser 10 to indicate the contents; but in other embodiments, an indicator (e.g., color, feel, etc.) is used to differentiate between the compartments. The hollow perforator 28 can be used to individually dispense the compartments 62a and/or 62b as desired by depressing the hollow perforator 28 to cause the perforator portion 32 to penetrate the desired compartments 62a and/or 62b.

FIG. 10B-10E are bottom views of the dispenser of the present invention as illustrated in FIG. 10A. FIG. 10B illustrates a 2 compartment dispenser 10 is designed to allow the individual dispensing of one or more components as desired. The dispenser 10 includes a fitting 14 having threads (not shown) to attach the dispenser 10 to the second container having mating threads (not shown). The fitting 14 has a fitting port (not shown) holding a reservoir (not shown) within the top of the second container (not shown). The reservoir (not shown) is sealed by a diaphragm 26 positioned opposite an orifice (not shown). The reservoir 22 is divided into separate compartments 62a and 62b by the divider 64 and seal (not shown) to allow each of the separate compartments 62a and 62b to hold different components (not shown). A hollow perforator (not shown) is slidably positioned in the orifice (not shown) of the reservoir (not shown) and includes a perforator portion (not shown) and an access port portion (not shown) opposite the perforator portion (not shown). A hollow perforator (not shown) may be twisted or rotated to position the perforator portion (not shown) over the corresponding compartments 62a and 62b. The hollow perforator (not shown) can be used to individually dispense the compartments 62a and/or 62b as desired by depressing the hollow perforator (not shown) to cause the perforator portion (not shown) to penetrate the desired compartments 62a and/or 62b

FIG. 10C illustrates a 3 compartment dispenser 10 is designed to allow the individual dispensing of one or more components as desired. The dispenser 10 includes a fitting 14 having threads (not shown) to attach the dispenser 10 to the second container having mating threads (not shown). The fitting 14 has a fitting port (not shown) holding a reservoir (not shown) within the top of the second container (not shown). The reservoir (not shown) is sealed by a diaphragm 26 positioned opposite an orifice (not shown). The reservoir 22 is divided into separate compartments 62a, 62b and 62c by the divider 64 and seal (not shown) to allow each of the separate compartments 62a, 62b and 62c to hold different components (not shown). A hollow perforator (not shown) is slidably positioned in the orifice (not shown) of the reservoir (not shown) and includes a perforator portion (not shown) and an access port portion (not shown) opposite the perforator portion (not shown). A hollow perforator (not shown) may be twisted or rotated to position the perforator portion (not shown) over the corresponding compartments 62a, 62b and 62c. The hollow perforator (not shown) can be used to individually dispense the compartments 62a, 62b and/or 62c as desired by depressing the hollow perforator (not shown) to cause the perforator portion (not shown) to penetrate the desired compartments 62a, 62b and/or 62c.

FIG. 10D illustrates a 4 compartment dispenser 10 is designed to allow the individual dispensing of one or more components as desired. The dispenser 10 includes a fitting 14 having threads (not shown) to attach the dispenser 10 to the second container having mating threads (not shown). The fitting 14 has a fitting port (not shown) holding a reservoir (not shown) within the top of the second container (not shown). The reservoir (not shown) is sealed by a diaphragm 26 positioned opposite an orifice (not shown). The reservoir 22 is divided into separate compartments 62a, 62b, 62c and 62d by the divider 64 and seal (not shown) to allow each of the separate compartments 62a, 62b, 62c and 62d to hold different components (not shown). A hollow perforator (not shown) is slidably positioned in the orifice (not shown) of the reservoir (not shown) and includes a perforator portion (not shown) and an access port portion (not shown) opposite the perforator portion (not shown). A hollow perforator (not shown) may be twisted or rotated to position the perforator portion (not shown) over the corresponding compartments 62a, 62b, 62c and 62d. The hollow perforator (not shown) can be used to individually dispense the compartments 62a, 62b, 62c and/or 62d as desired by depressing the hollow perforator (not shown) to cause the perforator portion (not shown) to penetrate the desired compartments 62a, 62b, 62c and/or 62d.

FIG. 10E illustrates a 5 compartment dispenser 10 is designed to allow the individual dispensing of one or more components as desired. The dispenser 10 includes a fitting 14 having threads (not shown) to attach the dispenser 10 to the second container having mating threads (not shown). The fitting 14 has a fitting port (not shown) holding a reservoir (not shown) within the top of the second container (not shown). The reservoir (not shown) is sealed by a diaphragm 26 positioned opposite an orifice (not shown). The reservoir 22 is divided into separate compartments 62a, 62b, 62c, 62d and 62e by the divider 64 and seal (not shown) to allow each of the separate compartments 62a, 62b, 62c, 62d and 62e to hold different components (not shown). A hollow perforator (not shown) is slidably positioned in the orifice (not shown) of the reservoir (not shown) and includes a perforator portion (not shown) and an access port portion (not shown) opposite the perforator portion (not shown). A hollow perforator (not shown) may be twisted or rotated to position the perforator portion (not shown) over the corresponding compartments 62a, 62b, 62c, 62d and 62e. The hollow perforator (not shown) can be used to individually dispense the compartments 62a, 62b, 62c, 62d and/or 62e as desired by depressing the hollow perforator (not shown) to cause the perforator portion (not shown) to penetrate the desired compartments 62a, 62b, 62c, 62d and/or 62e. The present invention may have more than 5 components and may combine the horizontal and vertical storage chambers as seen in FIG. 10.

The present invention is designed to combine one or more components that have been maintained separately from each other with one or more components in a reservoir of a dispenser and one or more components in an attached second container. This combination may be made from numerous states of matter and types of components to form an infinite number of mixtures. The reservoir and the second container may individually contain components that are a solid, a liquid, vapor, emulsion or a gel. For example, the reservoir and the second container may contain the same substances with differences in the concentration. The component in the reservoir and the second container may be similar or different in form and may themselves be mixtures of different forms, e.g., a solid, a liquid, vapor, or a gel. The individual components may be compositions or formulations in the form of powders, granules, microparticulates, nanoparticulates, emulsions, solution, suspension, cream, capsule, caplet, softgel, gelcap, elixir, syrup, emulsion, granule, jelly, foam, paste, pastille, pellet, lozenge, magma, or wafer and the like depending on the particular application.

The components used in conjunction with the present invention may be any product that is concentratable, e.g., vitamin, minerals, flavorings, fruit juices, lightly sweeteners, dietary supplements, syrups, beverages, dehydrated food products, coffees, teas, soups, dried fruits, powdered soups, powdered beverages, powdered milks, chocolate flavors, mint, cinnamon, and herb flavors, non-fruit flavors, shakes, gelatins, custards, puddings, fiber, a stress reducing formula, a mood enhancer, an anti-depressant, one or more pharmaceutically active compounds and/or the like. When in the form of a liquid, concentrate or beverage the present invention can be carbonated, uncarbonated, water, a flavored seltzer water, a soft drink, a mineral drink, juices, punches and concentrated forms of these beverages.

When in the form of concentrates of juice it refers to fruit juices, fruit flavors, vegetables, artificial flavors, and/or natural flavors, e.g., grape, pear, strawberry, passion fruit, pineapple, banana, lime, apple, lemon-lime, watermelon, melon, apricot, orange, lemon, grapefruit, apple, cranberry, tomato, mango, papaya, lime, tangerine, cherry, raspberry, blueberry, black berry, carrot, nonfruit edible plant parts, tubers, leaves, rinds, grains, nuts, cabbage, celery, cucumber, spinach, almond, coffee, cocoa, vanilla, beans and mixtures thereof. The components may also include commercially available products such as KOOL-AID™, HAWAIIAN PUNCH™, GATORADE™, CRYSTAL LIGHT™ or TANG™.

In addition to edible materials and compositions, the present invention may be used to keep other components separate. For example, the present invention may be used to keep a multiple part glue or epoxy separate until mixing and use. Similarly, the hair care industry can use the present invention to separate the color or dye portion from the conditioner, activator or developer portion. The skilled artisan will recognize that numerous applications for the present invention.

The hollow perforator may also be constructed out of a variety of materials with the most common being a plastic or a polymer material. The perforator portion may be of any desired diameter, length and width as necessary to hold the one or more components. For example, more concentrated components or less potent components allow a smaller hollow perforator to be used and conversely when more of a component is needed or the component is more dilute, a larger hollow perforator may be used. As a general rule, the component may be between 0.1% to about 75% by weight.

The diaphragm may be constructed from foil, plastic rubber, a polymer, a membrane and positioned immediately below the perforator portion of the hollow perforator. A downward motion results in the hollow perforator sliding toward and through the diaphragm to release the contents of the reservoir. The diaphragm may also be used to indicate tampering with the dispenser.

The individual components of the present invention may be made from any materials that do not adsorb the contents of the dispenser or leach-out contaminates into the dispenser. For example, the components may be constructed of one or more polymers including polyesters, polycarbonates, co-polymers of styrene and mixtures thereof. Examples of matrix polymers are acrylonitrile-butadiene-styrene terpolymer (ABS); ABS modified polyvinylchloride; ABS-polycarbonate blends; acrylic resins and co-polymers: poly(methacrylate), poly(ethylmethacrylate), poly(methylmethacrylate), methylmethacrylate or ethylmethacrylate copolymers with other unsaturated monomers; casein; cellulosic polymers: ethyl cellulose, cellulose acetate, cellulose acetatebutyrate; ethyl vinyl acetate polymers and copolymers; poly(ethylene glycol); poly(vinylpyrrolidone); acetylated mono-, di-glycerides and tri-glycerides; poly(phosphazene); chlorinated natural rubber; polybutadiene; polyurethane; vinylidene chloride polymers and copolymers; styrene-butadiene copolymers; styrene-acrylic copolymers; alkylvinylether polymers and copolymers; cellulose acetate phthalates; epoxies; ethylene copolymers: ethylene-vinyl acetate-methacrylic acid, ethylene-acrylic acid copolymers; methylpentene polymers; modified phenylene oxides; polyamides; melamine formaldehydes; phenolformaldehydes; phenolic resins; poly(orthoesters); poly(cyanoacrylates); polydioxanone; polycarbonates; polyesters; polystyrene; polystyrene copolymers: poly(styrene-co maleic anhydride); urea-formaldehyde; urethanes; vinyl resins: vinyl chloride-vinyl acetate copolymers, polyvinyl chloride and mixtures of two or more of these.

Furthermore, materials used in the present invention also include thermoplastics materials like acetal (e.g., produced by the polymerization formaldehyde [CH₂O] into both homopolymer and copolymer); acrylics; acrylic esters [CH₂CHCOOR]; methacrylic esters [CH₂C(CH₃)COOR]; methyl, ethyl, butyl, or 2-ethylhexyl acrylates; Acrylonitrile-Butadiene-Styrene (ABS) (e.g., styrene [C₆H₅CHCH₂] and varying amounts of acrylonitrile [CH₂CHCN] and butadiene [CH₂CHCHCH₂]); Alkyds, (e.g., unsaturated polyester resins produced by reacting an organic alcohol with an organic acid); styrene [C₆H₅CHCH₂]; diallyl phthalate [C₆H₄(COOCH₂CHCH₂)₂]; diacetone acrylamide [CH₃COCH₂C(CH₃)₂CHCHCONH₂]; vinyl toluene [CH₂CHC₆H₄CH₂]; cellulosics chemical modification of cellulose resins (e.g., (C₆H₁₀O₅)n); cellulose xanthate [ROCSSH]; cellulose acetate acetic acid ester [CH₃COOC₂H₅] of cellulose; cellulose acetate butyrate a mixed ester produced by treating fibrous cellulose with butyric acid [CH₃CH₂CH₂COOH], butyric anhydride [(CH₃CH₂CH₂CO)₂O], acetic acid [CH₃COOH] and acetic anhydride [(CH₃CO)₂O] in the presence of sulfuric acid [H₂SO₄]; cellulose propionate; coumarone-indene; diallyl phthalate (DAP) (e.g., monomer [C₆H₄(COOCH₂CHCH₂)₂] is used as a cross-linking agent in unsaturated polyester resins); epoxy containing one or more reactive epoxide or oxirane groups; fluoropolymer (e.g., fluoropolymers are: FEP (fluorinated ethylene-propylene) from tetrafluoroethylene [C₂F₄] and hexa-fluoropropylene [C₃F₆]; PTFE (polytetra fluoroethylene) from the polymerization of tetrafluoroethylene and ethylene [C₂H₄]; PFA (perfluoroalkoxy) from tetrafluoroethylene and perfluoropropyl vinyl ether [C₃H₇C₄OF₅]; PCTFE (polychlorotrifluoro-ethylene) from chlorotrifluoro-ethylene monomer [C₂F₃CI]; CTFE-VDF (polychlorotrifluoroethylenevinylidene fluoride) from chlorotrifluoroethylene and vinylidene fluoride [C₂H₂F₂]; E-CTFE (polyethylenechlorotrifluoroethylene) from chlorotrifluoroethylene and ethylene; PVDF (polyvinylidene fluoride) from vinylidene fluoride monomer; and PVF (polyvinyl fluoride) from vinyl fluoride monomer [C₂H₃F]); melamine-formaldehyde; nitrile resins; nylon (e.g., nylon 4 (polypyrrolidone)-a polymer of 2-pyrrolidone [CH₂CH₂CH₂C(O)NH]; nylon 6 (polycaprolactam)-made by the polycondensation of caprolactam [CH₂(CH₂)₄NHCO]; nylon 6/6-made by condensing hexamethylenediamine [H₂N(CH₂)₆NH₂] with adipic acid [COOH(CH₂)₄COOH]; nylon 6/10-made by condensing hexamethylenediamine with sebacic acid[COOH(CH₂)₈COOH]; nylon 6/12-made from hexamethylenediamine and a 12-carbon dibasic acid; nylon 11-produced by polycondensation of the monomer 11-amino-undecanoic acid [NH₂CH₂(CH₂)₉COOH]; nylon 12-made by the polymerization of laurolactam [CH₂(CH₂]₁₀CO)or cyclododecalactam, with 11 methylene units between the linking —NH—CO— groups in the polymer chain); petroleum resins; phenolic; polyamide-imide; polyarylates; polybutylene; polycarbonate; polyethylene; polyimides; polyphenylene oxide; polyphenylene sulfide; polypropylene; polystyrene; polyurethanes; polyvinyl acetate (PVAC) and other vinyls; polyvinyl chloride; styrene acrylonitrile; styrene butadiene latexes; styrene copolymers; sulfone polymers; polyethylene terephthalate (PET); unsaturated polyester; and combinations thereof.

In another example, the present invention may be produced by injection molding or machining (e.g., molding, milling, pressing, stamping and/or casting) material to a shape and using seals to prevent leaks. The materials of the present invention may be either as a whole or in part a metal, an alloy, a ceramic, a composite, a nonmetal, a polymer, a composite, a resist, a resin, a plastic or combinations thereof.

In addition, the present invention may be used for foodstuffs to prolong the freshness and storage life, while providing a convenient container. For example, a dehydrated foodstuff (e.g., MRE) may be placed in a container with a rehydrating liquid contained within the reservoir. When ready to consume, the rehydrating liquid is released from the reservoir to contact the dehydrated foodstuff where it is mixed and consumed. Although these are characterized as related to soft drinks, teas, KOOL-AID™, HAWAIIAN PUNCH™, GATORADE™, CRYSTAL LIGHT™, TANG™, concentrated drinks, foodstuffs and similar products it is it is equally applicable to pharmaceuticals.

The present invention also provides a pharmaceutical product in an individual dose container that includes two or more components in a non-premixed form. The individual dose container that keeps two or more substances separate up to their moment of usage, when they are mixed to maintain the therapeutic effect of the pharmaceutical product without the need for measuring and transferring the contents from container to container. The individual dose container includes a first component within a container having an aperture. A dispenser is fitted to the aperture by a fitting positioned circumferentially about a reservoir to attach the dispenser to the container. The reservoir has an orifice and a diaphragm positioned opposite the orifice and a hollow perforator slidably positioned in the orifice of the reservoir. The perforator includes a perforator portion and an access port portion opposite the perforator portion.

When used in conjunction with a pharmaceutical application the present invention may be used with an immediate release, extended release and/or delayed release compositions or formulations in the form of powders, granules, microparticulates, nanoparticulates, emulsions, solution, suspension, cream, capsule, caplet, softgel, gelcap, elixir, syrup, emulsion, granule, jelly, foam, paste, pastille, pellet, lozenge, magma, or wafer and the like depending on the particular application.

The term “immediate release” as used herein is used to describe a release profile to effect delivery of an active as soon as possible, that is, as soon as practically made available to an animal, whether in active form, as a precursor and/or as a metabolite. Immediate release may also be defined functionally as the release of over 80 to 90 percent (%) of the active ingredient within about 60, 90, 100 or 120 minutes or less. Immediate release as used herein may also be defined as making the active ingredient available to the patient or subject regardless of uptake, as some actives may never be absorbed by the animal. Immediate release formulations of the active on a carrier, such as rolled or compressed beads, may be formulated such that the surface area is maximized on beads and the active is exposed immediately. The immediate release formulations may also include effervescing agents that cause the disintegration of the structure integrity of the active and carrier such that release of the active is maximized. Various immediate release dosage forms may be designed readily by one of skill in art to achieve drug delivery to the stomach and small intestine, depending upon the choice of compression, adhesive materials and/or beading.

The terms “extended release” and “delayed release” as used herein is used to define a release profile to effect delivery of an active over an extended period of time, defined herein as being between about 60 minutes and about 2, 4, 6 or even 8 hours. Extended release may also be defined functionally as the release of over 80 to 90 percent (%) of the active ingredient after about 60 minutes and about 2, 4, 6 or even 8 hours. Extended release as used herein may also be defined as making the active ingredient available to the patient or subject regardless of uptake, as some actives may never be absorbed by the animal. Various extended release dosage forms may be designed readily by one of skill in art as disclosed herein to achieve delivery to both the small and large intestines, to only the small intestine, or to only the large intestine, depending upon the choice of coating materials and/or coating thickness.

“Extended release” and “delayed release” formulations may be prepared and delivered so that release is accomplished at some generally predictable location in the lower intestinal tract more distal to that which would have been accomplished if there had been no delayed release alterations. A method for delay of release is, e.g., a coating. Any coatings should be applied to a sufficient thickness such that the entire coating does not dissolve in the gastrointestinal fluids at pH below about 5, but does dissolve at pH about 5 and above. It is expected that any anionic polymer exhibiting a pH-dependent solubility profile can be used as an enteric coating in the practice of the present invention to achieve delivery to the lower gastrointestinal tract. Polymers and compatible mixtures thereof may be used to provide the coating for the delayed or the extended release of active ingredients, and some of their properties, include, but are not limited to: shellac, also called purified lac, a refined product obtained from the resinous secretion of an insect. This coating dissolves in media of pH>7.

The pharmaceutically active compounds useful in the practice of the present invention include antihistamines, decongestants, antitussives and/or expectorants. Other actives for use with the present invention include, but are not limited to: non-steroidal anti-inflammatory drugs (NSAIDs) and other analgesic drugs such as acetominophen and phenacetin. These materials are incorporated into the immediate release, extended release or controlled release formulations of the invention in amounts governed by the desired release characteristics of the material in such excipient base and such that conventional dosages comply with applicable FDA or other regulations.

Decongestants useful with the present invention (along with a salt form) are phenylephrine (bitartrate, tannate, HBr, HCl), phenylpropanolamine (HCl) and pseudoephedrine (HCl). Furthermore, a number of herbal and/or natural decongestants are known in the art, all of which may be used with the present invention.

Expectorants for use with the present invention include, e.g., guaifenesin, terpin hydrate, (glyceryl guaiacolate), potassium (iodide, citrate) and potassium guaicolsulfonate. Other expectorants, whether individual ingredients or combinations of ingredients may be used with the present invention.

Examples of antihistamines for use with the present invention (e.g., in salt form) are chlorpheniramine (maleate), brompheniramine (maleate), dexchlorpheniramine (maleate), dexbrompheniramine (maleate), triprolidine (HCl), diphenhydramine (HCl), doxylamine (succinate), tripelennamine (HCl), cyproheptatine (HCl), bromodiphenhydramine (HCl), phenindamine (tartrate), pyrilamine (maleate, tannate) and azatadine (maleate). Antitussives that may be used with the present invention (with salt form) include: caramiphen (edisylate), dextromethorphan (HBr) and codeine (phosphate, sulfate).

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A dispenser comprising:
a reservoir comprising an orifice and a diaphragm positioned opposite the orifice;
a hollow perforator slidably positioned in the orifice of the reservoir, the hollow perforator comprising a perforator portion and an access port portion opposite the perforator portion, wherein the reservoir and the hollow perforator form a chamber comprising one or more components; and
a fitting positioned circumferentially about the reservoir to attach the dispenser to a second container.

2. The dispenser of claim 1, wherein the fitting is a compression fitting, a threaded fitting, a friction fitting, a child proof fitting, or a combination thereof.

3. The dispenser of claim 1, wherein the one or more components comprise a liquid, a solid, a gel, a nano-particle, a pharmaceutical compound, an active agent, a coated particle, a mixture or a combination thereof.

4. The dispenser of claim 1, wherein a downward axial pressure on the hollow perforator ruptures the diaphragm.

5. The dispenser of claim 1, wherein the diaphragm is at least partially dislodged from the reservoir.

6. The dispenser of claim 1, wherein the access port portion is resealable.

7. The dispenser of claim 1, wherein the one or more components comprise vitamins, minerals, flavorings, fruit juices, lightly sweeteners, dietary supplements, syrups, beverages, dehydrated food products, coffees, teas, soups, dried fruits, powdered soups, powdered beverages, powdered milks, chocolate flavors, mint, cinnamon, herb flavors, non-fruit flavors, shakes, gelatins, custards, puddings, fiber, a stress reducing formula, a mood enhancer, an anti-depressant, one or more pharmaceutically active compounds.

8. The dispenser of claim 1, wherein the one or more components comprises one or more concentrates selected from fruit juices, fruit flavors, vegetables, artificial flavors, natural flavors, grape flavor, pear flavor, strawberry flavor, passion fruit flavor, pineapple flavor, banana flavor, lime flavor, apple flavor, lemon-lime flavor, watermelon flavor, melon flavor, apricot flavor, orange flavor, lemon flavor, grapefruit flavor, cranberry flavor, tomato flavor, mango flavor, papaya flavor, tangerine flavor, cherry flavor, raspberry flavor, blueberry flavor, black berry flavor, carrot flavor, tuber flavor, leave flavor, rind flavor, grain flavor, nut flavor, cabbage flavor, celery flavor, cucumber flavor, spinach flavor, almond flavor, coffee flavor, cocoa flavor, vanilla flavor, beans flavor, KOOL-AID™, HAWAIIAN PUNCH™, GATORADE™, CRYSTAL LIGHT™ and TANG™.

9. The dispenser of claim 1, wherein the second container comprises a carbonated liquid, uncarbonated, water, a flavored seltzer water, a soft drink, a mineral drink, juices, punches and concentrated forms of these beverages.

10. A method of dispensing one or more components for mixing comprising:
attaching a dispenser to a container, wherein the dispenser comprises a reservoir comprising an orifice and a diaphragm positioned opposite the orifice, a hollow perforator slidably positioned in the orifice of the reservoir, the hollow perforator comprising a perforator portion and an access port portion opposite the perforator portion, wherein the reservoir and the hollow perforator form a chamber comprising one or more components and a fitting positioned circumferentially about the reservoir to attach the dispenser to the container; and
sliding the hollow perforator to pierce the diaphragm and release the one or more components from the chamber into the container.

11. The method of claim 10, wherein the fitting comprising a compression fitting, a threaded fitting, a friction fitting, a child proof fitting, or a combination thereof.

12. The method of claim 10, wherein the one or more components comprise a liquid, a solid, a gel, a nano-particle, a pharmaceutical compound, an active agent, a coated particle, a mixture or a combination thereof.

13. The method of claim 10, wherein a downward axial pressure on the hollow perforator ruptures the diaphragm.

14. The method of claim 10, wherein the access port portion is resealable.

15. The method of claim 10, wherein the one or more components comprise vitamins, minerals, flavorings, fruit juices, lightly sweeteners, dietary supplements, syrups, beverages, dehydrated food products, coffees, teas, soups, dried fruits, powdered soups, powdered beverages, powdered milks, chocolate flavors, mint, cinnamon, herb flavors, non-fruit flavors, shakes, gelatins, custards, puddings, fiber, a stress reducing formula, a mood enhancer, an anti-depressant, one or more pharmaceutically active compounds.

16. The method of claim 10, wherein the one or more components comprises one or more concentrates selected from fruit juices, fruit flavors, vegetables, artificial flavors, natural flavors, grape flavor, pear flavor, strawberry flavor, passion fruit flavor, pineapple flavor, banana flavor, lime flavor, apple flavor, lemon-lime flavor, watermelon flavor, melon flavor, apricot flavor, orange flavor, lemon flavor, grapefruit flavor, cranberry flavor, tomato flavor, mango flavor, papaya flavor, tangerine flavor, cherry flavor, raspberry flavor, blueberry flavor, black berry flavor, carrot flavor, tuber flavor, leave flavor, rind flavor, grain flavor, nut flavor, cabbage flavor, celery flavor, cucumber flavor, spinach flavor, almond flavor, coffee flavor, cocoa flavor, vanilla flavor, beans flavor, KOOL-AID™, HAWAIIAN PUNCH™, GATORADE™, CRYSTAL LIGHT™ and TANG™.

17. The method of claim 10, wherein the container comprises a carbonated liquid, uncarbonated, water, a flavored seltzer water, a soft drink, a mineral drink, juices, punches and concentrated forms of these beverages.

18. A container for dispensing one or more components comprising:
a container comprising a first component and an aperture; and
a dispenser fitted to the aperture, wherein the dispenser comprises a reservoir comprising an orifice and a diaphragm positioned opposite the orifice, a hollow perforator slidably positioned in the orifice of the reservoir, the perforator comprising a perforator portion and an access port portion opposite the perforator portion, wherein the reservoir and the hollow perforator form a chamber comprising one or more components, and a fitting positioned circumferentially about the reservoir to attach the dispenser to the first container.

19. The dispenser of claim 18, wherein a downward axial pressure on the hollow perforator ruptures the diaphragm.

20. The dispenser of claim 18, wherein the one or more components comprise vitamins, minerals, flavorings, fruit juices, lightly sweeteners, dietary supplements, syrups, beverages, dehydrated food products, coffees, teas, soups, dried fruits, powdered soups, powdered beverages, powdered milks, chocolate flavors, mint, cinnamon, herb flavors, non-fruit flavors, shakes, gelatins, custards, puddings, fiber, a stress reducing formula, a mood enhancer, an anti-depressant, one or more pharmaceutically active compounds, fruit juices, fruit flavors, vegetables, artificial flavors, natural flavors, grape flavor, pear flavor, strawberry flavor, passion fruit flavor, pineapple flavor, banana flavor, lime flavor, apple flavor, lemon-lime flavor, watermelon flavor, melon flavor, apricot flavor, orange flavor, lemon flavor, grapefruit flavor, cranberry flavor, tomato flavor, mango flavor, papaya flavor, tangerine flavor, cherry flavor, raspberry flavor, blueberry flavor, black berry flavor, carrot flavor, tuber flavor, leave flavor, rind flavor, grain flavor, nut flavor, cabbage flavor, celery flavor, cucumber flavor, spinach flavor, almond flavor, coffee flavor, cocoa flavor, vanilla flavor, beans flavor, KOOL-AID™, HAWAIIAN PUNCH™, GATORADE™, CRYSTAL LIGHT™ and TANG™.

21. The dispenser of claim 18 wherein the second container comprises a carbonated liquid, uncarbonated, water, a flavored seltzer water, a soft drink, a mineral drink, juices, punches and concentrated forms of these beverages.
